(19) United States
(12) Patent Application Publication
(10) Pub. No.: US 2011/0013188 A1
(43) Pub. Date: Jan. 20, 2011

(54) Object Alignment Measurement Method and Apparatus

(75) Inventors: Daan Maurits SLOTBOOM, Rhenen (NL); Petrus Anton Willem Cornelia Maria Van Eijck, Budel (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 12/838,200

(22) Filed: Jul. 16, 2010

Related U.S. Application Data
(60) Provisional application No. 61/226,117, filed on Jul. 16, 2009.

(51) Int. Cl. G01B 11/00; G06F 19/00

(52) U.S. Cl. 356/401; 702/150

(57) ABSTRACT

A lithographic apparatus includes apparatus for measuring the alignment of an object. The measuring apparatus includes a plurality of alignment sensors, each including an alignment detector for measuring the position of an alignment mark over an alignment detection area. The measuring apparatus further includes a leveling sensor for measuring the height and/or tilt of an object in a leveling sensor detection area, and a feed-forward connection between said leveling sensor and said alignment sensors.

### CROSS-REFERENCE TO RELATED APPLICATION

This application claims priority and benefit under 35 U.S.C. § 119(e) to U.S. Provisional Patent Application No. 61/226,117, entitled “Inspection Method and Apparatus, Lithographic Apparatus, Lithographic Processing Cell and Device Manufacturing Method,” filed on Jul. 16, 2009. The content of that application is incorporated herein in its entirety by reference.

### FIELD

The present invention relates to an object alignment measurement method and apparatus, as usable, for example, in the manufacture of devices by lithographic techniques.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti parallel to this direction. It is also possible to transfer the pattern from the patterning device to the substrate by imprinting the pattern onto the substrate.

In order to monitor the lithographic process, it is necessary to measure parameters of the patterned substrate, for example the overlay error between successive layers formed in or on it. There are various techniques for making measurements of the microscopic structures formed in lithographic processes, including the use of scanning electron microscopes and various specialized tools. One form of specialized inspection tool is a scatterometer in which a beam of radiation is directed onto a target on the surface of the substrate and properties of the scattered or reflected beam are measured. By comparing the properties of the beam before and after it has been reflected or scattered by the substrate, the properties of the substrate can be determined. This can be done, for example, by comparing the reflected beam with data stored in a library of known measurements associated with known substrate properties. Two main types of scatterometer are known. Spectroscopic scatterometers direct a broadband radiation beam onto the substrate and measure the spectrum (intensity as a function of wavelength) of the radiation scattered into a particular narrow angular range. Angularly resolved scatterometers use a monochromatic radiation beam and measure the intensity of the scattered radiation as a function of angle.

Before exposure by a lithographic apparatus, a wafer has to be measured and aligned, for the accurate placement of a pattern on the surface, for example to ensure correct overlay between successive patterned layers. It is known to provide multiple alignment sensors, as described for example in US 2008/0088843, hereby incorporated by reference. The multiple alignment heads are used to measure a number of alignment marks in parallel to improve throughput. However, with multiple alignment heads calibration of the alignment head system becomes difficult and so improvements are needed to improve calibration of multiple alignment heads, to improve overlay accuracy and product yield.

### SUMMARY

According to a first aspect of the disclosure there is provided a lithographic apparatus comprising apparatus for measuring the alignment of an object, comprising a plurality of alignment sensors, each comprising an alignment detector for measuring the position of an alignment mark over an alignment detection area; and a leveling sensor for measuring the height and/or tilt of an object in a leveling sensor detection area; and a feed-forward connection between said leveling sensor and said alignment sensors.

According to a second aspect of the disclosure there is provided a method of measuring the alignment of an object in or associated with a lithographic apparatus, comprising; measuring the position of a plurality of alignment marks, each measurement being made over an alignment detection area; measuring the height and/or tilt of an object in a leveling sensor detection area; and feeding-forward the measured height and/or tilt to provide a correction for the measured position of a plurality of alignment marks.

According to a third aspect of the disclosure there is provided a method of exposing a wafer, comprising reconstructing a wafer model, said reconstruction of the wafer model comprising measuring the alignment of the wafer by measuring the alignment of an object in or associated with a lithographic apparatus, comprising; measuring the position of a plurality of alignment marks, each measurement being made over an alignment detection area; measuring the height and/or tilt of an object in a leveling sensor detection area; and feeding-forward the measured height and/or tilt to provide a correction for the measured position of a plurality of alignment marks; and carrying out an exposure based on said reconstructed wafer model.

According to a fourth aspect of the disclosure there is provided a lithographic apparatus comprising apparatus for measuring the alignment of an object, comprising a stage for carrying an object; a measuring device for measuring the position of said stage; a plurality of alignment sensors, each comprising an alignment detector for measuring the position of an alignment mark over an alignment detection area; a mechanism for moving said alignment sensors between one or more successive positions in a first direction without being moved in a second direction; and a calculator for comparing the output of the measuring device at two or more of the successive positions with the output of said alignment sensors; and for calculating a discrepancy in the shape of said stage based on said outputs.

According to a fifth aspect of the disclosure there is provided lithographic apparatus comprising apparatus for measuring the alignment of an object, comprising a plurality of alignment sensors, each comprising an alignment detector for measuring the position of an alignment mark over an alignment detection area; and a plurality of leveling sensors for measuring the height and/or tilt of an object in a leveling sensor detection area; each leveling sensor being dedicated for use with one or more of the alignment sensors.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus;

FIG. 2 depicts a lithographic cell or cluster;

FIG. 3 depicts a first scatterometer;

FIG. 4 depicts a second scatterometer;

FIG. 5 depicts a first example of a stage unit;

FIG. 6 shows a second example of a stage unit;

FIG. 7 shows a first example of an encoder system, in which a diffraction grating is provided on a metrology frame and a sensor is provided on a wafer stage;

FIG. 8 shows a second example of an encoder system; in which a diffraction grating is provided on a wafer stage and a sensor is provided on a metrology frame;

FIG. 9 shows a schematic plan view of a multiple alignment head system;

FIG. 10 shows the multiple head alignment system of FIG. 9 attached to an encoder system;

FIG. 11 depicts an initial position in an alignment measurement process;

FIG. 12 shows a subsequent step in an alignment measurement process;

FIG. 13 illustrates the depth of focus of alignment heads with respect to an uneven surface;

FIG. 14 shows a first step of a primary alignment system calibration procedure;

FIG. 15 shows a second stage of a primary alignment system calibration procedure;

FIG. 16 shows a first step of a secondary alignment system calibration procedure;

FIG. 17 shows a second step of a secondary alignment system calibration procedure;

FIGS. 18 and 19 show plan and side views of an arrangement for feed-forward of height sensor data to alignment sensors;

FIGS. 20 and 21 show the measurement errors caused by uneven mirror surfaces; and

FIGS. 22 to 26 show scanning and measurement operations.

### DETAILED DESCRIPTION

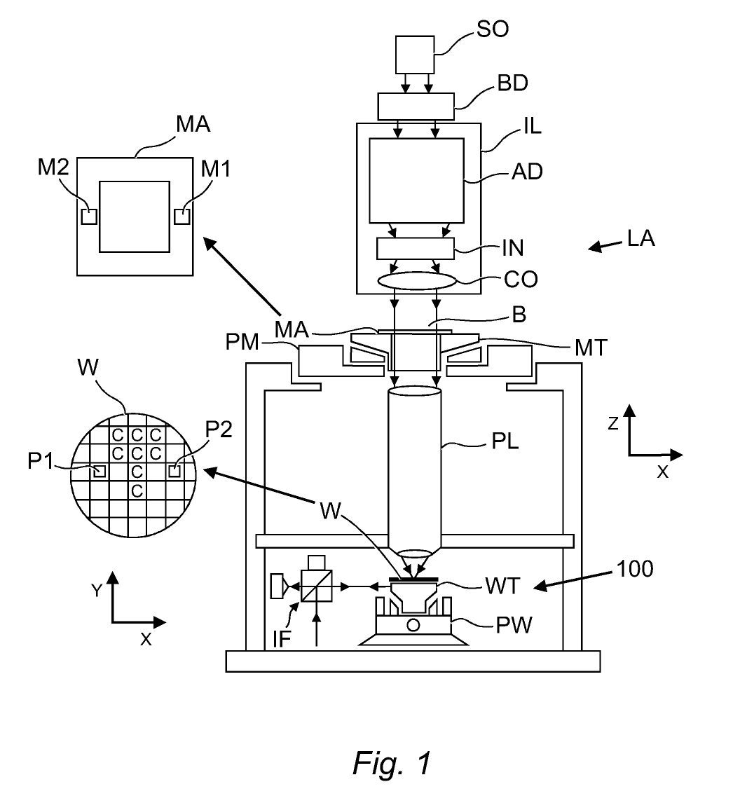

FIG. 1 schematically depicts a lithographic apparatus. The apparatus comprises:
an illumination system (illuminator) IL configured to condition a radiation beam B (e.g. UV radiation or DUV radiation).
a support structure (e.g. a mask table) MT constructed to support a patterning device (e.g. a mask) MA and connected to a first positioner PM configured to accurately position the patterning device in accordance with certain parameters
a stage unit 100 comprising at least one substrate table (e.g. a wafer table) WT constructed to hold a substrate (e.g. a resist coated wafer) W, and, optionally, a measurement table comprising various sensors. The stage unit also comprises various components for moving and controlling the substrate table(s) and/or measurement table (FIG. 1 shows a second positioner PW configured to accurately position the substrate held by the substrate table WT in accordance with certain parameters). In the following description the terms “stage” and “table” can generally be used interchangeably unless the specific context otherwise dictates. The apparatus further comprises
a projection system (e.g. a refractive projection lens system) PL configured to project a pattern imparted to the radiation beam B by patterning device MA onto a target portion C (e.g. comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure supports, i.e. bears the weight of, the patterning device. It holds the patterning device in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam, which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The stage unit 100 provided as part of the lithographic apparatus LA can have various different configurations. In one configuration, the lithographic apparatus may be of a type having one substrate table WT and one measurement table. In an alternative embodiment, the lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may comprise an adjuster AD for adjusting the angular intensity distribution of the radiation beam. Generally, at least the outer and/or inner radial extent (commonly referred to as a-outer and a-inner, respectively) of the intensity distribution in a pupil plane of the illuminator can be adjusted. In addition, the illuminator IL may comprise various other components, such as an integrator IN and a condenser CO. The illuminator may be used to condition the radiation beam, to have a desired uniformity and intensity distribution in its cross section.

The radiation beam B is incident on the patterning device (e.g., mask MA), which is held on the support structure (e.g., mask table MT), and is patterned by the patterning device. Having traversed the mask MA, the radiation beam B passes through the projection system PL, which focuses the beam onto a target portion C of the substrate W. With the aid of the second positioner PW and position sensor IF (e.g. an interferometric device, linear encoder, 2-D encoder or capacitive sensor), the substrate table WT can be moved accurately, e.g. so as to position different target portions C in the path of the radiation beam B. Similarly, the first positioner PM and another position sensor (which is not explicitly depicted in FIG. 1) can be used to accurately position the mask MA with respect to the path of the radiation beam B, e.g. after mechanical retrieval from a mask library, or during a scan. In general, movement of the mask table MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the mask MA, the mask alignment marks may be located between the dies.

The depicted apparatus could be used in at least one of the following modes:

1. In step mode, the mask table MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the mask table MT and the substrate table WT are scanned synchronously while a pattern imparted to the radiation beam is projected onto a target portion C (i.e. a single dynamic exposure). The velocity and direction of the substrate table WT relative to the mask table MT may be determined by the (de-)magnification and image reversal characteristics of the projection system PL. In scan mode, the maximum size of the exposure field limits the width (in the non-scanning direction) of the target portion in a single dynamic exposure, whereas the length of the scanning motion determines the height (in the scanning direction) of the target portion.

3. In another mode, the mask table MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

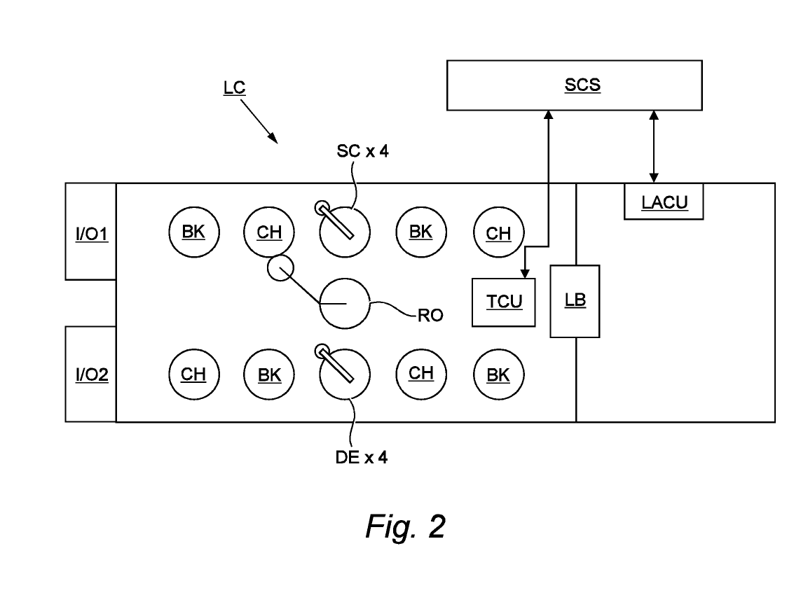

As shown in FIG. 2, the lithographic apparatus LA forms part of a lithographic cell LC, also sometimes referred to a lithocell or cluster, which also includes apparatus to perform pre- and post-exposure processes on a substrate. Conventionally these include spin coaters SC to deposit resist layers, developers DE to develop exposed resist, chill plates CH and bake plates BK. A substrate handler, or robot, RO picks up substrates from input/output ports I/O1, I/O2, moves them between the different process apparatus and delivers them to the loading bay LB of the lithographic apparatus. These devices, which are often collectively referred to as the track, are under the control of a track control unit TCU which is itself controlled by the supervisory control system SCS, which also controls the lithographic apparatus via lithography control unit LACU. Thus, the different apparatus can be operated to maximize throughput and processing efficiency.

In order that the substrates that are exposed by the lithographic apparatus are exposed correctly and consistently, it is desirable to inspect exposed substrates to measure properties such as overlay errors between subsequent layers, line thicknesses, critical dimensions (CD), etc. If errors are detected, adjustments may be made to exposures of subsequent substrates, especially if the inspection can be done soon and fast enough that other substrates of the same batch are still to be exposed. Also, already exposed substrates may be stripped and reworked—to improve yield—or discarded, thereby avoiding performing exposures on substrates that are known to be faulty. In a case where only some target portions of a substrate are faulty, further exposures can be performed only on those target portions which are good.

An inspection apparatus is used to determine the properties of the substrates, and in particular, how the properties of different substrates or different layers of the same substrate vary from layer to layer. The inspection apparatus may be integrated into the lithographic apparatus LA or the lithocell LC or may be a stand-alone device. To enable most rapid measurements, it is desirable that the inspection apparatus measure properties in the exposed resist layer immediately after the exposure. However, the latent image in the resist has a very low contrast—there is only a very small difference in refractive index between the parts of the resist which have been exposed to radiation and those which have not—and not all inspection apparatus have sufficient sensitivity to make useful measurements of the latent image. Therefore measurements may be taken after the post-exposure bake step (PEB) which is customarily the first step carried out on exposed substrates and increases the contrast between exposed and unexposed parts of the resist. At this stage, the image in the resist may be referred to as semi-latent. It is also possible to make measurements of the developed resist image—at which point either the exposed or unexposed parts of the resist have been removed—or after a pattern transfer step such as etching. The latter possibility limits the possibilities for rework of faulty substrates but may still provide useful information.

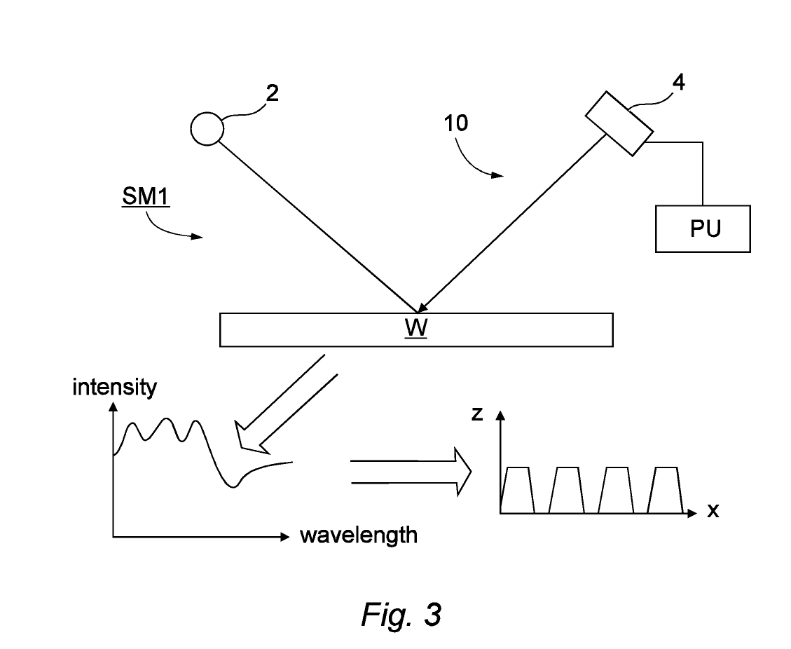

FIG. 3 depicts a scatterometer which may be used in the present invention. It comprises a broadband (white light) radiation projector 2 which projects radiation onto a substrate W. The reflected radiation is passed to a spectrometer detector 4, which measures a spectrum 10 (intensity as a function of wavelength) of the specular reflected radiation. From this data, the structure or profile giving rise to the detected spectrum may be reconstructed by processing unit PU, e.g. by Rigorous Coupled Wave Analysis and non-linear regression or by comparison with a library of simulated spectra as shown at the bottom of FIG. 3. In general, for the reconstruction the general form of the structure is known and some parameters are assumed from knowledge of the process by which the structure was made, leaving only a few parameters of the structure to be determined from the scatterometry data. Such a scatterometer may be configured as a normal-incidence scatterometer or an oblique-incidence scatterometer.

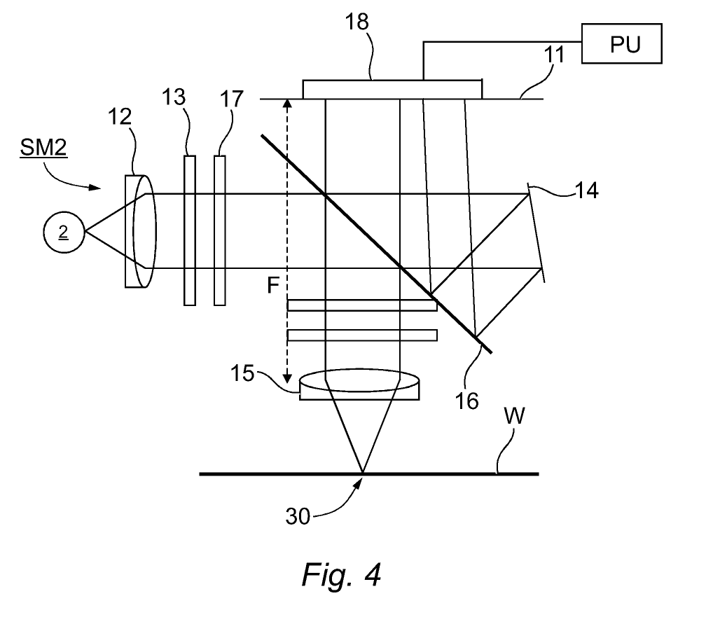

Another scatterometer that may be used with the present invention is shown in FIG. 4. In this device, the radiation emitted by radiation source 2 is focused using lens system 12 through interference filter 13 and polarizer 17, reflected by partially reflected surface 16 and is focused onto substrate W via a microscope objective lens 15. Immersion scatterometers may even have lenses with numerical apertures over 1. The reflected radiation then transmits through partially reflective surface 16 into a detector 18 in order to have the scatter spectrum detected. The detector may be located in the back-projected pupil plane 11, which is at the focal length of the lens system 15, however the pupil plane may instead be re-imaged with auxiliary optics (not shown) onto the detector. The pupil plane is the plane in which the radial position of radiation defines the angle of incidence and the angular position defines the azimuth angle of the radiation. The detector may be a two-dimensional detector so that a two-dimensional angular scatter spectrum of a substrate target 30 can be measured. The detector 18 may be, for example, an array of CCD or CMOS sensors, and may use an integration time of, for example, 40 milliseconds per frame.

A reference beam is often used for example to measure the intensity of the incident radiation. To do this, when the radiation beam is incident on the beam splitter 16, a part of the radiation beam is transmitted through the beam splitter as a reference beam towards a reference mirror 14. The reference beam is then projected onto a different part of the same detector 18.

A set of interference filters 13 is available to select a wavelength of interest in the range of, for example, 405-790 nm or even lower, such as 200-300 nm. The interference filter may be tunable rather than comprising a set of different filters. A grating could be used instead of interference filters.

The detector 18 may measure the intensity of scattered light at a single wavelength (or a relatively narrow wavelength range), the intensity may be measured separately at multiple wavelengths or integrated over a wavelength range. Furthermore, the detector may separately measure the intensity of transverse magnetic- and transverse electric-polarized light and/or the phase difference between the transverse magnetic- and transverse electric-polarized light.

Using a broadband light source (i.e. one with a wide range of light frequencies or wavelengths—and therefore of colors) is possible, which gives a large attenuation, allowing the mixing of multiple wavelengths. In an embodiment, each of the plurality of wavelengths in the broadband has a bandwidth of Δλ and a spacing of at least 2 Δλ (i.e. twice the bandwidth). Several “sources” of radiation can be different portions of an extended radiation source which have been split using fiber bundles. In this way, angle resolved scatter spectra can be measured at multiple wavelengths in parallel. A 3-D spectrum (wavelength and two different angles) can be measured, which contains more information than a 2-D spectrum. This allows more information to be measured which increases metrology process robustness. This is described in more detail in EP1,628,164A.

The target 30 on substrate W may be a grating, which is printed such that after development, the bars are formed of solid resist lines. The bars may alternatively be etched into the substrate. This pattern is sensitive to chromatic aberrations in the lithographic projection apparatus, particularly the projection system PL, and illumination symmetry and the presence of such aberrations will manifest themselves in a variation in the printed grating. Accordingly, the scatterometry data of the printed gratings is used to reconstruct the gratings. The parameters of the grating, such as line widths and shapes, may be input to the reconstruction process, performed by processing unit PU, from knowledge of the printing step and/or other scatterometry processes.

As mentioned above, before exposure of a substrate can take place, the alignment and other characteristics of the substrate need to be determined and it is therefore necessary to perform a measurement process before the exposure process can be performed. The measurement process is vital to obtain information about the alignment of the substrate and to ensure correct overlay between successive layers of patters to be formed on the substrate. Typically a semiconductor device may have tens or even hundreds of patterned layers, which need to be overlaid with high accuracy otherwise the devices cannot function correctly.

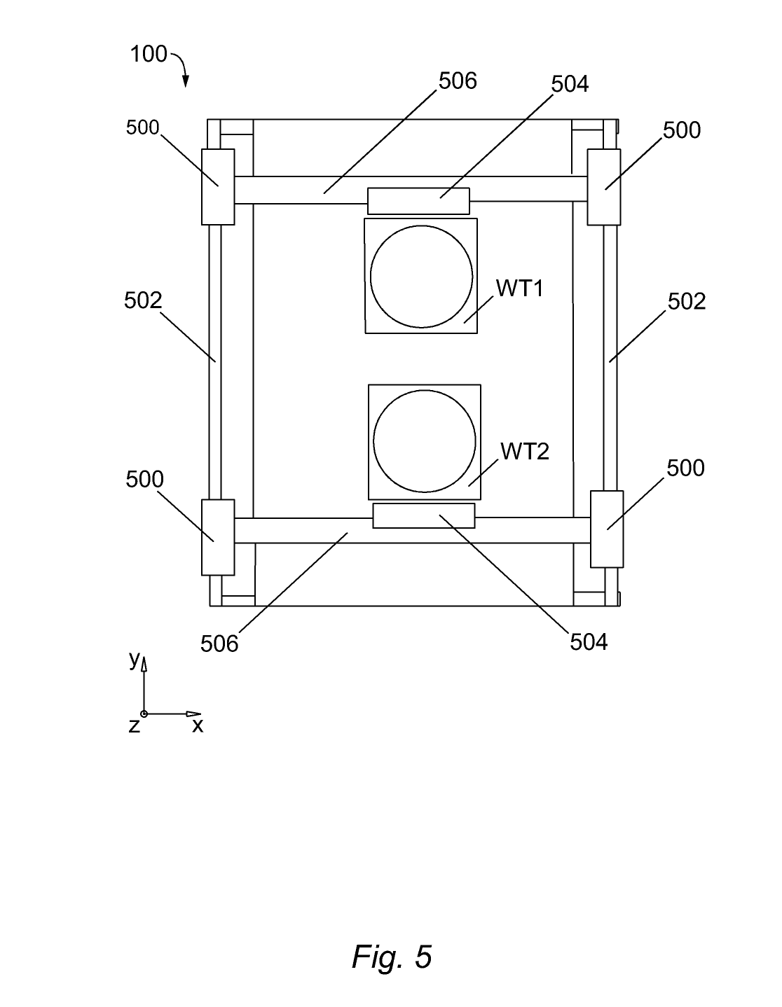

FIG. 5 shows a first example of a stage unit 100. In this and other figures, references to the x and y directions are generally taken to mean the respective orthogonal axes in the plane of the substrate or substrate table, namely the horizontal plane. References to the z-direction are taken to mean a direction in an axis orthogonal to the x and y axes, namely a vertical direction. The z-direction can also be referred to as “height”. It is to be appreciated however that the labeling of one axis as “x”, one as “y” and one as “z” is in essence arbitrary. The figures are provided with references to guide the reader as to the designation of a particular axis as “x”, “y” or “z” in each case.

The stage unit 100 comprises a first substrate table WT1 and a second substrate table WT2. Both substrate tables are suitable to receive and support a substrate, typically a wafer. In use, one of the substrate tables will be positioned beneath the projection system PL while it performs an exposure, while at the same time the other of the substrate tables can be positioned with respect to various sensor components to perform measurement of the substrate carried by the substrate table.

In the example embodiment of FIG. 5 a component for moving and controlling the substrate tables WT1 and WT2 comprises a motor with Y-sliders 500 arranged to slide along rails 502 in the y-axis and X-sliders 504 arranged to slide along rails 506 in the X-axis so that the position of the wafer tables in the X and Y axis can be changed. Because of the shape of the rails 506, 502, this type of arrangement is referred to herein as an H drive motor or mechanism. An alternative to this H drive mechanism is to use a planar motor wherein the motor directly drives the wafer tables.

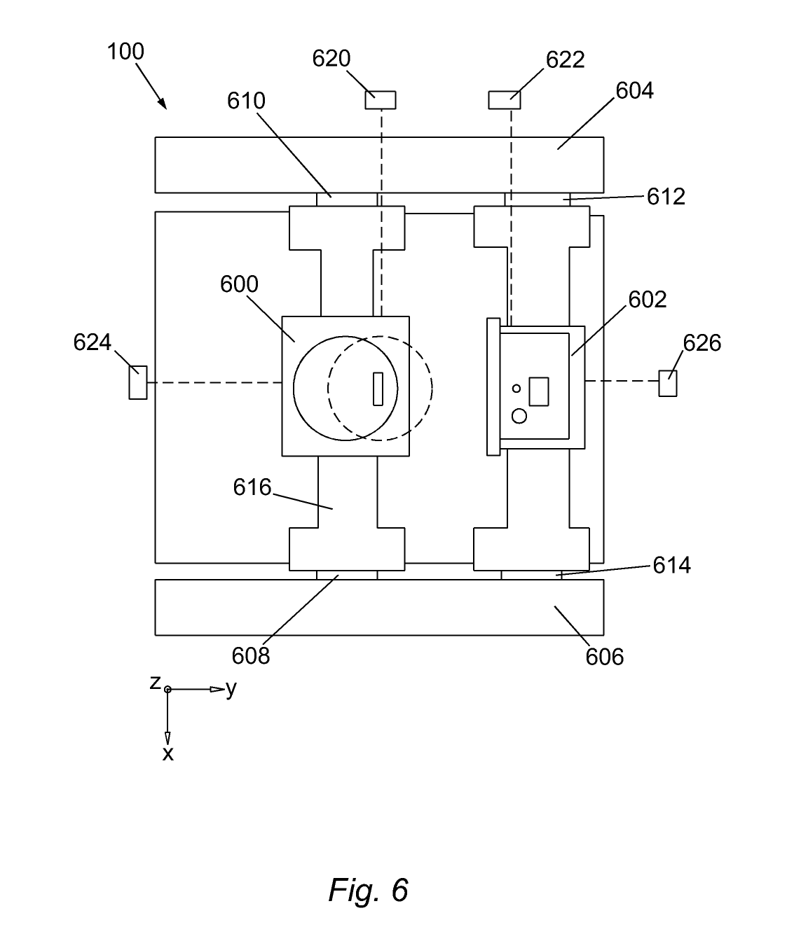

FIG. 6 shows an alternative embodiment of a stage unit 100 which comprises a separate wafer stage 600 and measurement stage 602. The stage unit 100 is provided with Y-axis stators 604, 606 and the wafer stage 600 is moveable along the Y-axis by Y-axis movers 608, 610 while the measurement stage 602 is moveable along the Y-axis by Y-axis movers 612, 614. The Y-axis stators 604, 606 in combination with the Y-axis movers 608, 610 form a Y-axis linear motor for moving the wafer stage 600, while the Y-axis stators 604, 606 in combination with the Y-movers 612, 614 form a Y-axis linear motor for driving the measurement stage 602 in the Y direction. In one embodiment the stators 604, 606 can be composed of a magnetic pole unit comprising a plurality of permanent magnets comprising alternately placed north and south poles along the Y-axis direction, while the movers 608, 610, 612, 614 can comprise in each case an armature unit incorporating armature coils placed at predetermined distances along the Y-axis direction. This is referred to as a moving coil type Y-axis linear motor.

The wafer stage 600 and the measurement stage 602 are positioned on X-axis stators 616, 618 respectively. The X-axis stators 616, 618 may for example comprise an armature unit which incorporates armature coils placed at a predetermined distance along the X-axis direction. Openings in the wafer stage 600 and measurement stage 602 can comprise a magnetic pole unit comprising a plurality of permanent magnets made up of alternating pairs of north and south pole magnets. The magnetic pole unit and stators constitute a moving magnet type X-axis linear motor provided for driving the wafer stage 600 along an X direction as illustrated in the figure, and a second similar moving magnet type linear motor for driving the measurement stage 602 along the X direction as shown in the figure.

Therefore, the Y and X-axis linear motors form components for moving and controlling the wafer stage 600 and measurement stage 602. Mechanisms for determining the positions of the wafer stages will be discussed later. However, in FIG. 6 interferometers 620, 622, 624 and a 626 are provided for measurement of the X and Y positions of each of the stages. The beams from the interferometers (shown as dotted lines in the figure) reflect from polished mirrored surfaces of the respective stages 600, 602 (these surfaces extend in the Z direction as shown in the figure, namely out of the page) and the time taken for a beam to be reflected is used as a measurement of the position of the stage along the X or Y axis.

The accuracy of control of a wafer stage using interferometers is limited by air fluctuations in the relatively long optical paths of the interferometer beams. An alternative to interferometers is to use an encoder for determining the position of the wafer stages.

It is common for a lithographic apparatus to include both an encoder system together with an interferometer system. The encoder system in this case will generally be the main system used for measurement of the positions of the stages in the X and Y-axis, with the interferometer system being provided for use during testing or calibration of the encoder system or as a back-up positional detection system if there are cases where the encoder system cannot be used (for example in the system of FIG. 6 a Y-axis interferometer needs to be used to measure the Y position of the wafer stage 600 near the unloading position or the loading position for wafer replacement and also at the point between a loading operation and an alignment operation and/or between an exposure operation and an unloading operation).

An encoder system may, for example, comprise a sensor element and a diffraction grating. The sensor element is arranged to detect radiation reflected from or transmitted through the diffraction grating and to detect the periodic pattern which can be fed from the sensor to a computer for calculating the position represented by the encoded values.

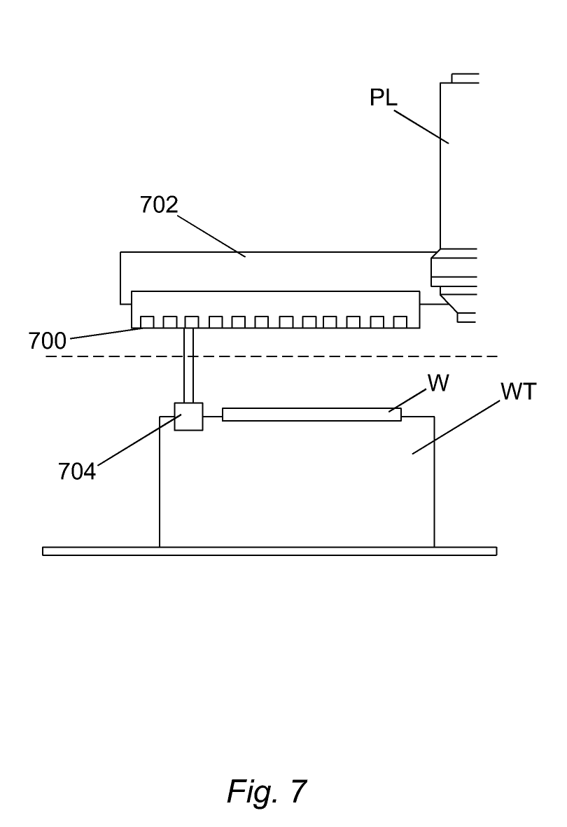

FIG. 7 shows an embodiment where a diffraction grating 700 is provided on a metrology frame 702, with a sensor 704 being provided on a wafer stage WT1 holding a wafer W. In this embodiment the metrology frame 702 is fixedly attached to the project unit PL.

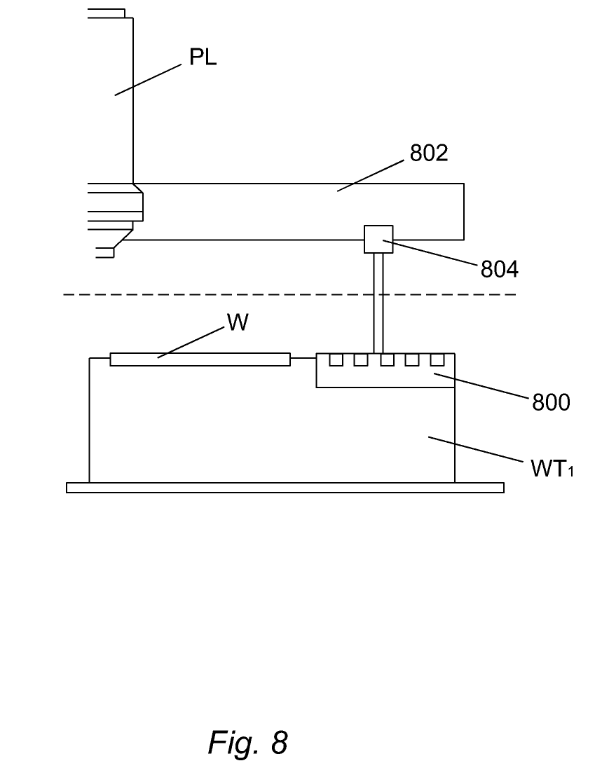

FIG. 8 shows an alternative embodiment wherein the diffraction grating is provided at the wafer stage WT1 holding a wafer W and a sensor element 804 is provided on a metrology frame 802 which in this example again is fixedly attached to the projection unit PL.

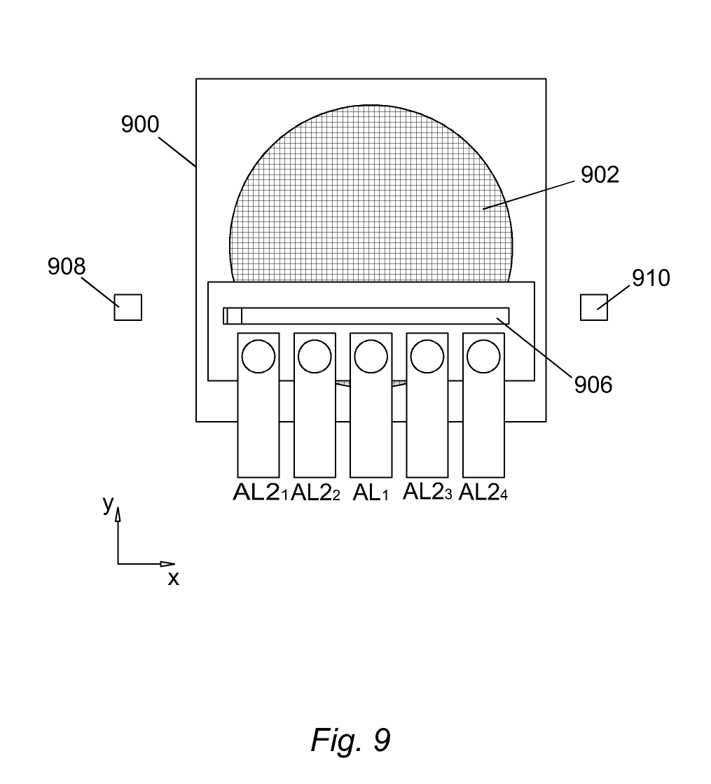

One of the key tasks in the measurement stage is the alignment measurement of a wafer. One example alignment system is shown in the FIG. 9. This alignment system incorporates multiple alignment heads AL1 and AL21, AL22, AL23 and AL24. Different numbers and arrangements of alignment heads are possible. The alignment heads are shown generically in FIG. 9 as being positioned over a wafer stage 900 which can be for example the wafer stage 600, WT1 or WT2 as shown in previous figures, or other wafer stages for example.

Wafer stage 900 is shown as holding a wafer 902. In this example five alignment heads are provided. A central alignment head AL1 forms part of a primary alignment system and so is referred to as a “primary alignment head”, while the outer alignment heads AL21, AL22, AL23 and AL24 form part of a secondary alignment system, and so are referred to as “secondary alignment heads”. Also shown in FIG. 9 is a leveling sensor with radiation source 908 and radiation detector 910, which will be described in more detail later.

Each alignment head AL1, AL21, AL22, AL23, AL24 comprises a sensor element which is designed to detect an alignment mark, which can be provided on the wafer or on the wafer stage; or on the measurement stage if applicable. The alignment mark can be, for example, a specially printed feature at a point on the wafer, for example, an alignment mark can be printed on the scribe lanes which run between successive columns and/or rows of die elements on the wafer. It is also possible to use a feature of the pattern formed on the wafer as an alignment marker or to use specific alignment marks which are printed within the die elements on the wafer.

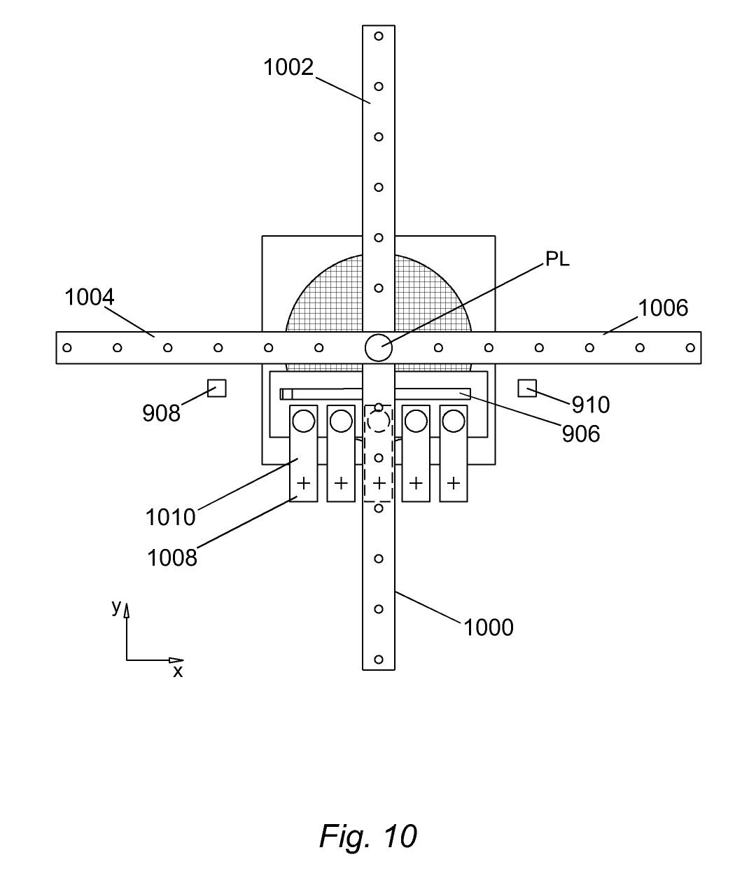

The alignment heads AL1, AL21, AL22, AL23, AL24 may be attached to a metrology frame which includes encoder sensors, as illustrated in FIG. 10. In this figure the primary alignment head AL1 is fixed to the underside surface of a first Y encoder 1000. The apparatus further comprises a second Y encoder 1002 and first and second X encoders 1004, 1006. The first and second Y encoders may be provided as a single component and the first and second X encoders may also be provided as a single component.

In the illustration of FIG. 10 the encoders are all fixedly attached to the project unit PL. This corresponds to the embodiment shown in FIG. 8—each encoder sensor corresponds to the sensors 804 which are positioned to detect the position with a diffraction grating provided on the wafer table. As an alternative the sensors may be provided on the wafer table and look up towards diffraction gratings provided on the metrology frame.

The secondary alignment heads AL21, AL22, AL23, AL24 are moveable in the X direction. In one embodiment each of the secondary alignment heads AL21, AL22, AL23, AL24 is fixed to a turning end of an arm that can turn around a rotation centre in a predetermined angle range in clockwise and anti-clockwise directions (rotation centre 1008, arm 1010). The X axis position of the secondary alignment heads AL21, AL22, AL23, AL24 can also be adjusted by a drive mechanism that drives the secondary alignment heads back and forth in the X direction. It is also possible for the secondary alignment heads to be driven in the Y direction.

Once the arms of the secondary alignment systems are moved to a given location a fixing mechanism is selectively operable to hold the arms in position. The fixing mechanism may comprise a vacuum pad that is composed of a differential type air bearing which can be activated to fix the arm 1010 to the main frame by suction after the rotation adjustment of the arm is complete. Other fixing mechanisms may be used, for example, forming a portion of the main frame arm as a magnetic body and using an electromagnet.

The image sensors used in the alignment heads may, for example be a field image alignment system or other appropriate image sensor. The field image alignment system irradiates a broadband detection beam that does not expose resist on a wafer to a subject alignment mark, and picks up an image of the subject mark formed on a light receiving plane by the reflected light from the subject mark and an image of an index, which can be an index pattern on an index plate arranged within each alignment head. In general any alignment sensor can be used which irradiates a coherent detection light to a subject mark and detects a scattered light or a diffracted light generated from the subject mark, or makes two diffracted lights generated from the subject mark interfere and to detect an interference light.

It is to be noted that the alignment system in FIG. 9 comprises five alignment heads, however other numbers of alignment heads could be used, including both odd and even numbers.

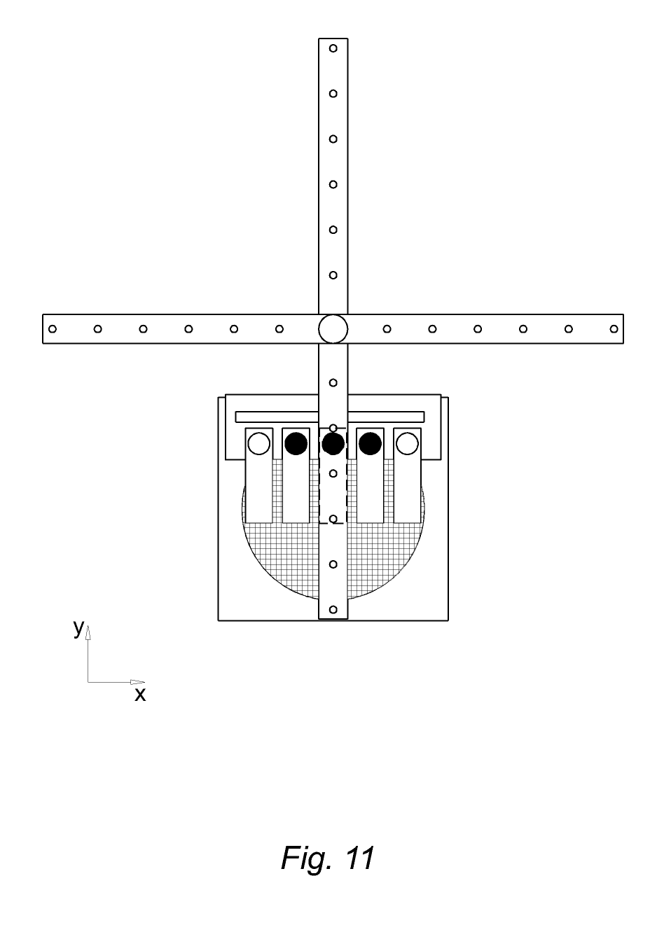

An alignment operation using the alignment head and encoder embodiments shown in FIGS. 9 and 10 will now be described. It is to be appreciated that similar alignment operations can be carried out using the other embodiments mentioned. In an alignment process the wafer table is positioned at an initial position as shown in FIG. 11. In this example three of the alignment heads, namely the primary alignment head AL1 and its two nearest neighbors AL22 and AL23, detect alignment marks on the wafer. The outlying alignment heads which do not detect alignment marks are in an embodiment switched off. However they may be switched on if required for other purposes. A filled-in shape represents an alignment head that is active.

The wafer stage is then moved from the initial detection position to a second detection position at which a number of the alignment heads perform a measurement of respective alignment marks on the wafer. A number of measurement positions can be defined along the Y-axis with the multiple alignment heads measuring multiple alignment marks at each position.

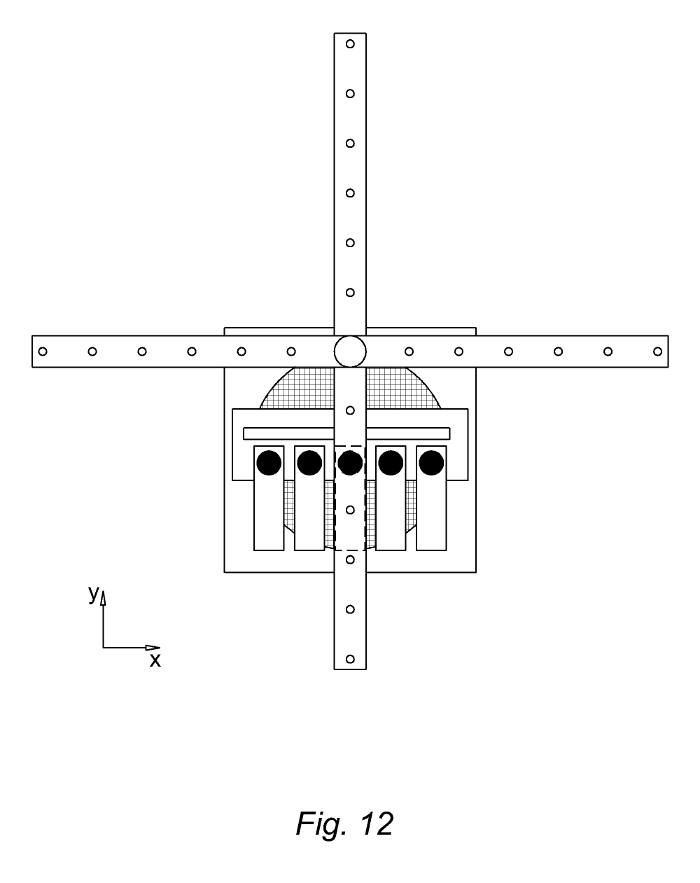

FIG. 12 shows a further alignment detection position in which all five alignment heads are active (i.e. all alignment heads are indicated with a filled-in shape in FIG. 12). It is to be appreciated that any suitable number of alignment detection positions can be chosen. The more positions that are chosen the more accurate the system can be, although the more time consuming the alignment process will be. For example, it is possible to define sixteen alignment marks in successive rows along the X-axis on the wafer comprising three, five, five and three marks respectively which can then be detected by four different alignment positions which make use of three, five, five and three alignment heads respectively. The number of rows of alignment marks can be less or more than five and can even be as high as many hundreds.

The measurements carried out by multiple alignment heads are carried out simultaneously where possible. However, due to the differing height along the surface of a wafer, a leveling process is typically carried out. This can be performed by moving the wafer stage up and down in the Z-axis as controlled by a further encoder system. Alternatives to this will be discussed below. A z-leveling sensor 906, 908, 910 is provided which uses a focus detection technique to determine when the wafer is in line with a predetermined focal plane of the leveling sensor. In an embodiment the position of the wafer stage in the X-axis is set so that the primary alignment system AL1 is placed on the centre line of wafer table WTB and primary alignment system AL1 detects the alignment mark which is on the meridian of the wafer.

The data from the alignment sensors AL1, AL21, AL22, AL23, AL24 can then be used by a computer to compute an array of all the alignment marks on the wafer in a co-ordinate system that is set by the measurement axis of the x and y encoders and the height measurements by performing statistical computations in a known manner using the detection results of the alignment marks and the corresponding measurement values of the encoders, together with the baseline calibration of the primary alignment system and secondary alignment system, which will be discussed in more detail below.

In the above embodiment the wafer stage can be moved in the Y direction and the measurements of the marks can be made without moving the wafer in the X direction. However it is to be appreciated that an alignment system as illustrated may be moveable in the X direction to collect additional measurements for computing the array of alignment marks, for example in the case where a larger wafer is to be measured and/or a smaller number of alignment heads are to be used and/or the alignment heads are to be spaced together within a shorter X-axis range.

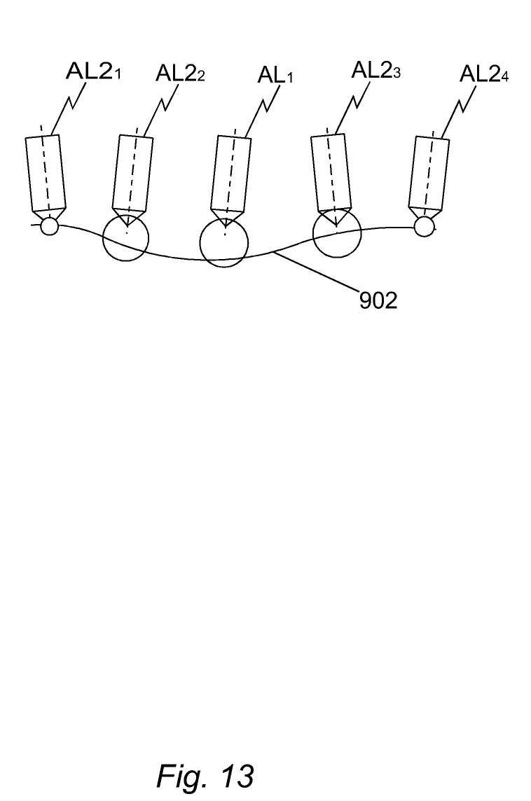

The surface of a wafer is not a flat plane and has some unevenness for example due to manufacturing tolerances as well as the unevenness introduced by the patterns which are formed on its surface. This means that it is highly probably that at least one alignment head performs detection of an alignment mark out of focus. FIG. 13 shows an exaggerated example of this, where the middle three alignment heads AL22, AL1 and AL23 are out of focus with respect to the uneven wafer 902 surface.

Changing the relative position in the Z-axis of the wafer table allows each of the alignment heads to make a measurement in a focused state, although each movement in the Z-axis which is required results in an additional step and additional time that is required for the alignment. Further, the optical axis of the alignment system will not always coincide with the Z-axis direction due to a combination of the angular unevenness of the wafer surface, and the angular displacement of the arms of the secondary alignment system (in the case of the embodiment where the arms are rotatable). However, it is possible to measure the tilt with respect to the Z-axis of the optical axis of the alignment heads in advance so that the detection results of positions of the alignment marks can be corrected based on the measurement results.

Before the alignment process can be carried out however, a baseline calibration of the alignment system has to be carried out to ensure that it is correctly calibrated. A baseline calibration of the primary alignment system will now be described.

Firstly, the wafer is aligned against the fixed primary alignment head. The wafer stage has a fiducial mark for providing a reference point for the measurement of the position of the wafer stage. The fiducial mark may be provided in a fixed positional relation to an imaging system arranged to detect radiation incident on the fiducial mark. During the primary baseline calibration the reticle is aligned against the fixed primary alignment head AL1.

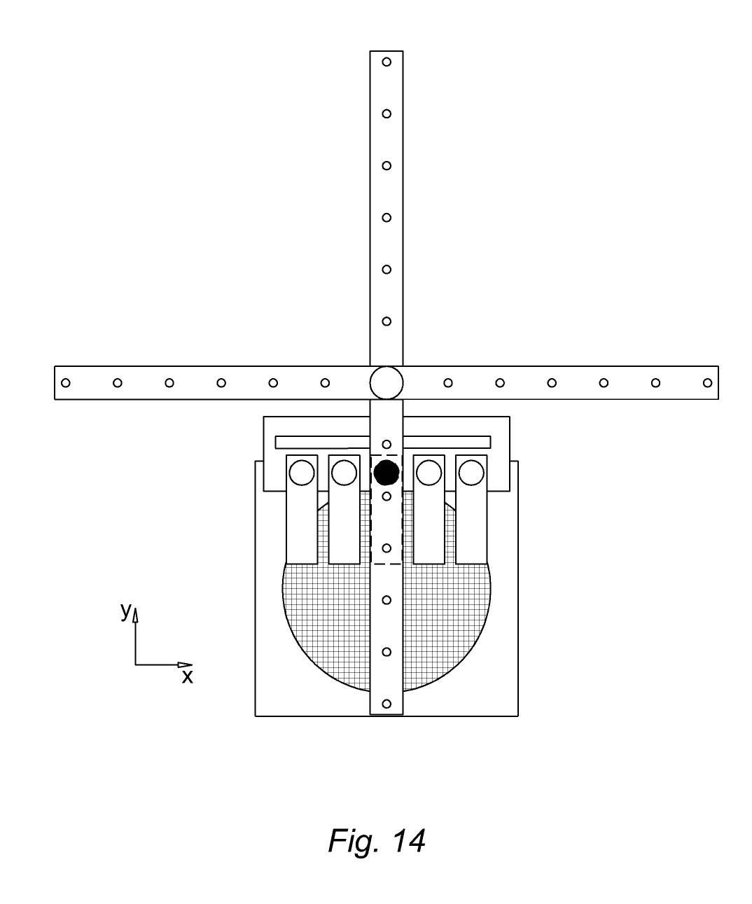

In a first stage of this primary baseline calibration, alignment head AL1 is positioned above the fiducial mark of the wafer stage and the X-Y position of the measurement is recorded, as shown in FIG. 14.

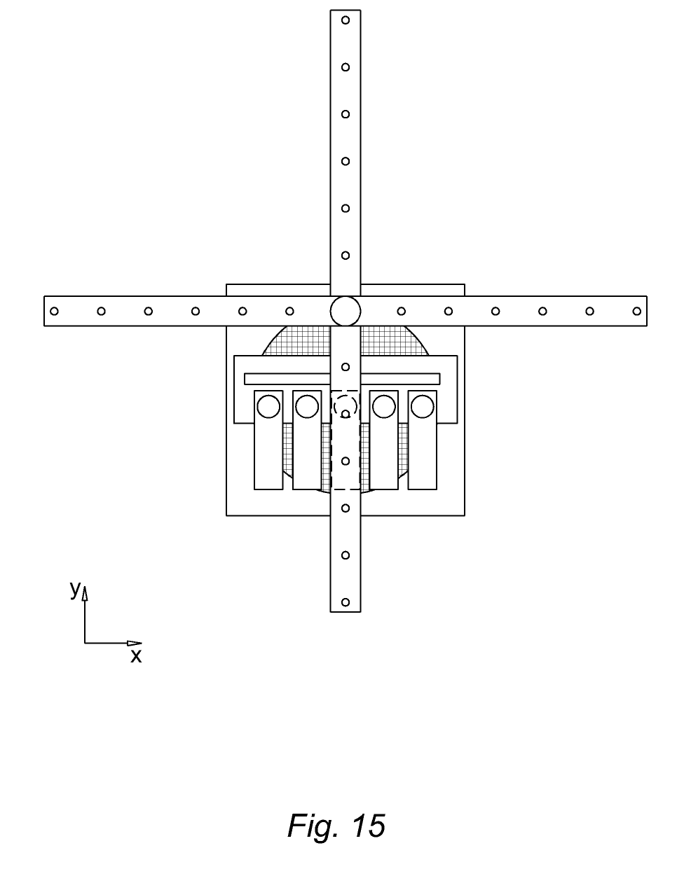

Then the substrate table is moved (along the Y direction as shown in the figure) to a second position, shown in FIG. 15, in which the fiducial mark is located directly below the projection optical system PL and a known point on the reticle (defined by a reticle alignment mark) is projected on to the fiducial mark and detected by the image sensor which co-operates with the fiducial mark. This position of the projected image is also recorded and the relative difference between the two recorded positions is used to calculate the alignment of the fixed alignment head AL1 with respect to the reticle. This is known as a primary baseline calibration.

Following the primary baseline calibration a secondary baseline calibration is performed to calculate the relative positions of the secondary alignment heads AL21, AL22, AL23, AL24 with respect to the fixed primary alignment head AL1. This secondary baseline calibration needs to be performed at the start of every lot of wafers to be processed.

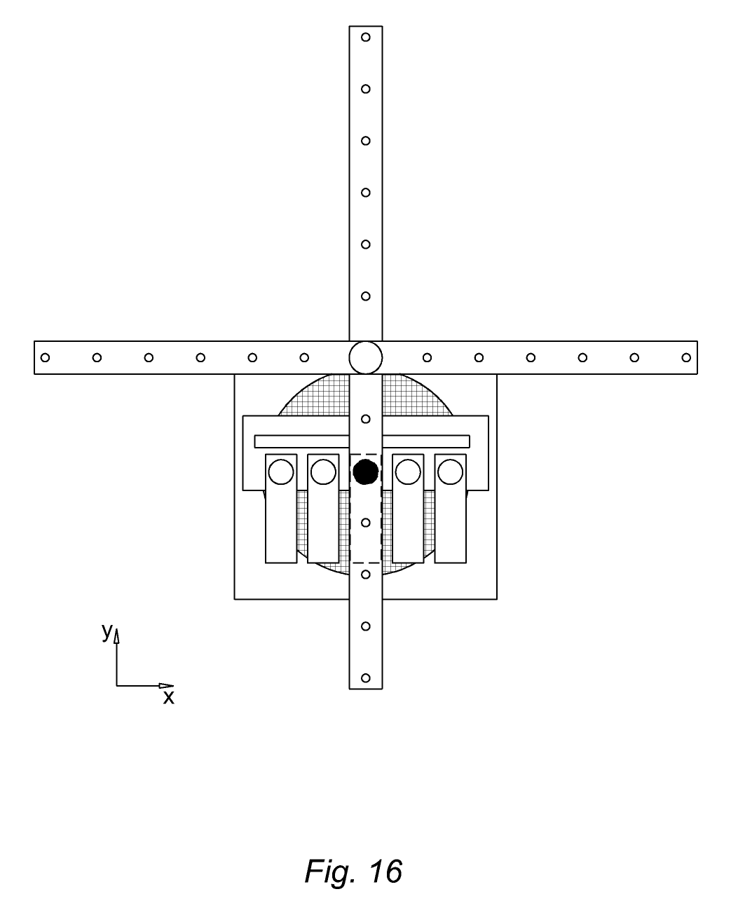

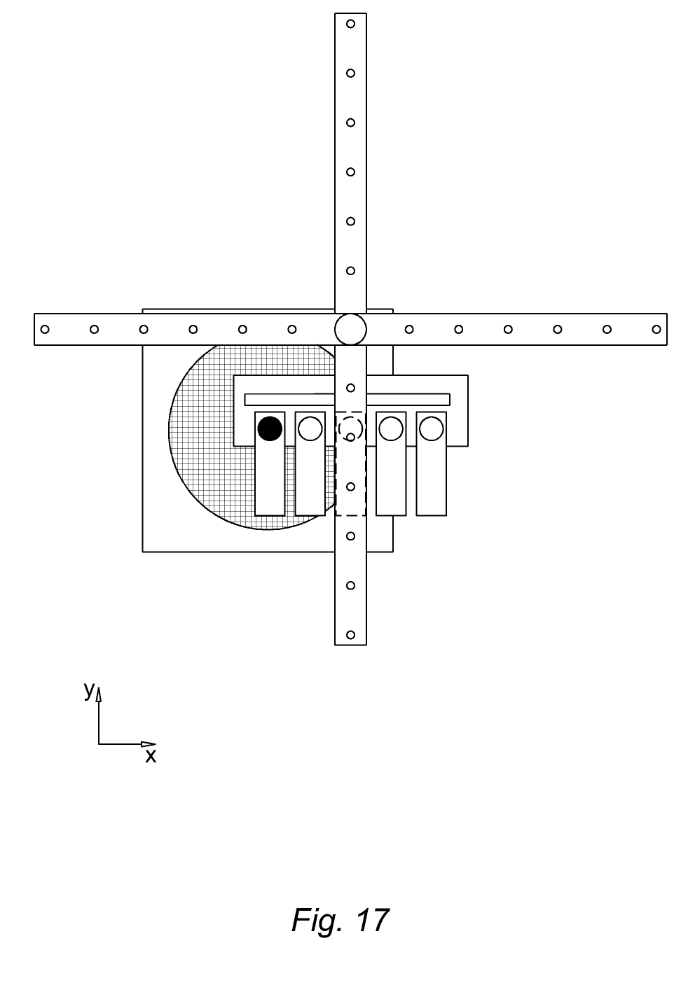

In an example, a wafer comprises five alignment marks in a specific row M1, M2, M3, M4 and M5. One of the alignment marks M3 in the illustrated example is measured with the primary alignment heads AL1 as shown in FIG. 16 where again a filled-in shape is used to represent the alignment heads which are active (in this case, only the primary alignment head AL1). The wafer stage is then moved in the X direction by a known amount and then the same wafer alignment mark M3 is measured with one of the secondary alignment heads. FIG. 17 shows the measurement of the same mark with the secondary alignment head AL21.

The X-Y position measured is then stored in memory and compared with the X-Y position of mark M3 as detected with AL1 together with the known distance by which the wafer stage has moved, in order to calculate the baseline position of secondary alignment head AL21 with respect to primary alignment head AL1.

The wafer stage is then moved in the positive X direction so that the same wafer alignment mark M3 is measured with the adjacent secondary alignment head, AL22, whose X-Y position is calibrated with respect to the primary alignment head AL1 in the same manner. This is then repeated for the remaining secondary alignment heads AL23 and AL24.

The difference in detection offset among the alignment systems can then be corrected in subsequent processing of data.

It is also possible to perform a secondary baseline calibration based on reference points other than an alignment mark on the wafer, for example an alignment mark on the wafer stage, measurement stage.

It is also possible to provide a plurality of datum marks in the same positional relation as that of the alignment heads AL21, AL22, AL23, AL24 so that each of the secondary alignment heads can measure their respective dedicated datum point in parallel. The datum points have a known positional relation with respect to the fiducial mark, which enables calibration of the position information of each of the secondary alignment heads with respect to the primary alignment head to be calculated based on the acquired measurements.

In a variation of the first method, a plurality of alignment marks can be measured in parallel by each of the secondary alignment heads. Then the wafer is moved (for example in an X direction) and the primary alignment head is used to measure an alignment mark previously measured by one of the secondary alignment heads. The measured X-Y positions of the secondary alignment head and the primary alignment head for that mark, together with the known offset introduced by the wafer movement are used to calculate the baseline of the secondary alignment head. This process is then repeated for each of the alignment marks so that each of the secondary alignment heads is calibrated with respect to the primary alignment head AL1.

In the quest for ever better overlay more alignment marks need to be measured with more precision. However this takes up time, making the alignment process slower, costing throughput.

Furthermore, a type of multiple head alignment system is described above which involves a pivot of the secondary alignment heads in order to adjust their positions (usually in an x-direction). The pivoting of the alignment heads creates unwanted dynamic effects which harm the alignment accuracy.

These problems can be solved by a new alignment technique. As described above, a measurement system comprises alignment sensors for measuring alignment marks, and various sensors for measuring the position of various components in the x,y and z axes. These components include leveling sensors for measuring focus, and z-position sensors for measuring the position of respective components in the z-direction. Encoder systems and/or interferometer systems are provided for measuring the position of respective components in the x and y directions. A leveling sensor can be used to measure the height and tilt of a wafer.

In a new alignment technique, multiple alignment sensors are employed and the height and/or tilt measurements from a leveling sensor are fed forward to the alignment sensors. The alignment sensors then receive the height and/or tilt measurements and use it to correct the alignment measurements for offsets in the z-direction. Given a certain offset in height the aligned position can be corrected once the telecentricity (x,y displacement as a function of z) of the stage or alignment sensor is known.

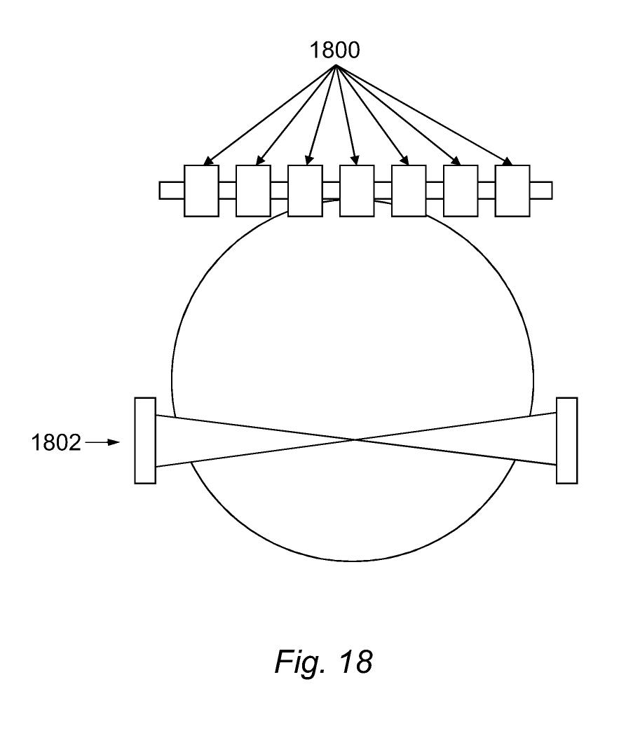

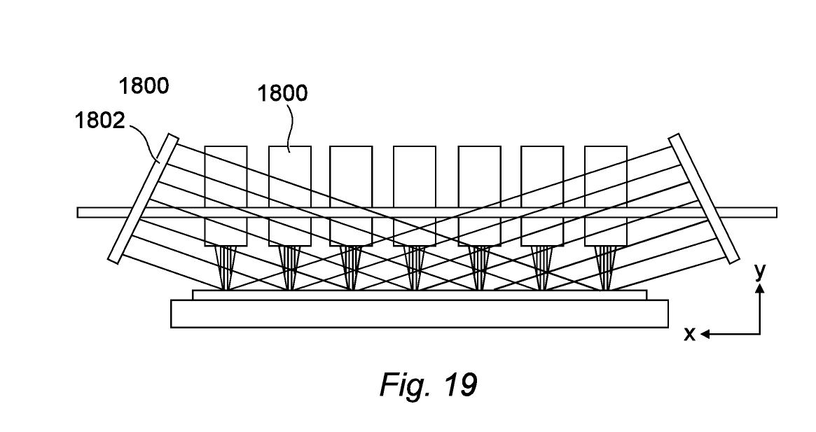

FIG. 18 shows a representative system for this feed-forward technique, showing in this example seven alignment sensors 1800, and a leveling sensor 1802. FIG. 19 shows a side view of the system of FIG. 18, with the beams irradiated by the leveling sensor 1802 shown.

Therefore in the new technique measurements are performed in parallel, in contrast to the prior art technique of measuring the alignment with one pass and the leveling data with another pass. By feed forwarding data from the leveling sensor to the alignment system no separate corrections for z have to be made since the alignment system corrects for this. This makes the alignment measurement more stable and robust.

The secondary alignment systems can move relative with respect to each other, while the central (primary) alignment sensor is fixed and used as a datum point to be referenced by the other alignment sensors.

The distance of the secondary alignments systems with respect to the central alignment sensor can be measured by using measurements taken from the projected image from a reticle, passed through the lens elements of the lithographic apparatus, as a reference. After this the alignment sensors can then each measure a separate scribe lane with a known relative position between them. For example, the alignment sensors can move via an optical guiding rail and they may be fixed via a magnetic or mechanical device. The detectors used for the secondary alignment sensors can be the same as the central alignment sensor, or can be completely separate optical devices. Even webcam-like sensors can be considered for use as secondary or primary alignment sensors.

So, the height and/or tilt data is fed forward to the x/y measurement step and used during the x/y measurement step for the determination of optimal focus. The height and/or tilt data can also be fed forward to a step of reconstructing a wafer model for exposure, before an exposure step is then carried out.

This new technique results in an increase in speed of alignment due to the parallel processing of alignment and height and/or tilt data. The reduction in measurement times then translates into cheaper production costs and furthermore to increased accuracy as more data is scanned than in a standard process.

The use of multiple alignment sensors gives the opportunity to align multiple times on a single mark with each time a different sensor. Via this method a mark can be measured at various positions of the wafer stage yielding valuable information on the positioning system.

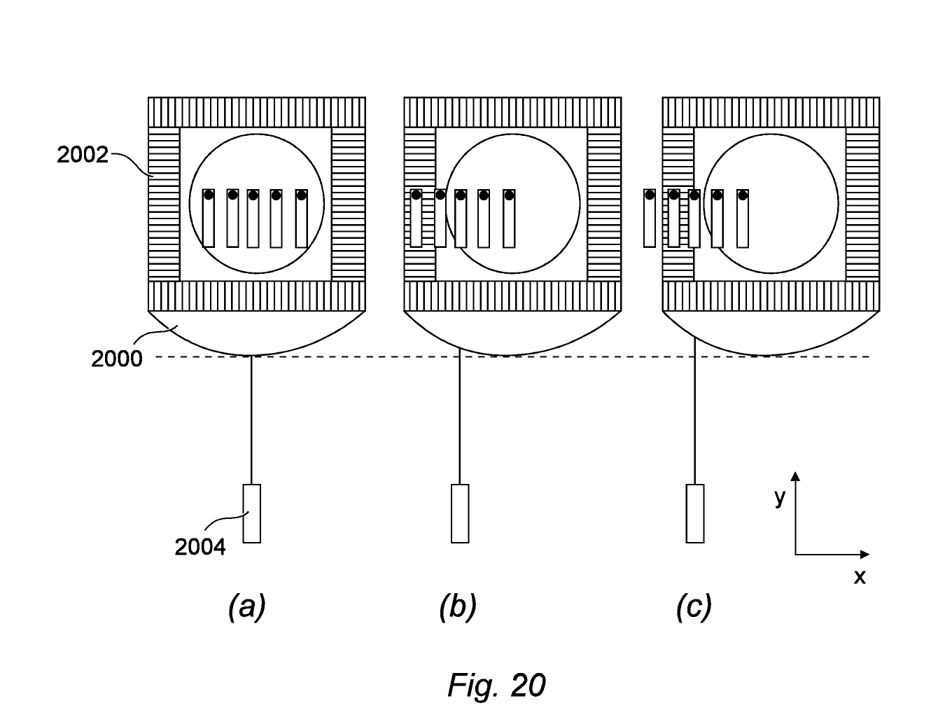

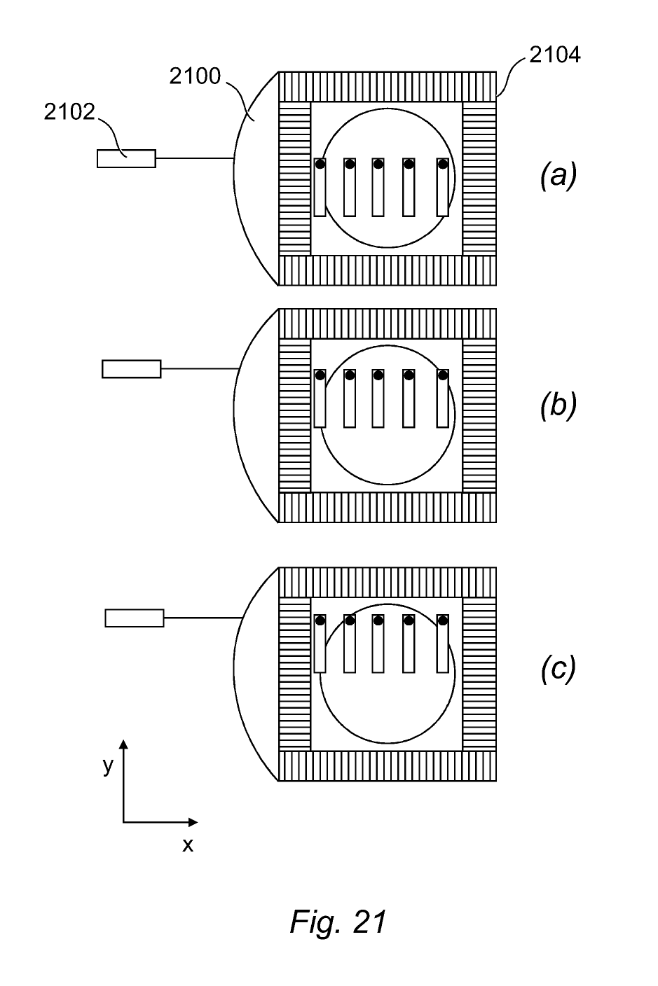

Calibration can be carried out to compensate for any unevenness of the interferometer mirrors at the sides of the wafer table(s) and/or measurement table(s) that are used in the interferometer positioning systems. FIG. 20 shows the problem that can be caused. In the figure, the Y-mirror 2000 of a wafer table 2002 is shown as being deformed (the deformation is not to scale—it has been vastly exaggerated for ease of illustration). In successive x-positions of the wafer (shown at positions 20a, 20b and 20c), the deformed y-mirror 2000 results in a variation of readings that are given by the interferometer 2004—for the specific shape of deformation shown in FIG. 20, the measured y-position increases for each successive x-position. FIG. 21 shows how the same problem occurs when the x-mirror 2100 is deformed, with the readings given by an interferometer 2102 varying for successive y-positions of the wafer table 2104 (shown at positions 21a, 21b and 21c).

A calibration process to account for unevenness in the x and/or y mirrors can advantageously make use of the multiple alignment heads for increased speed.

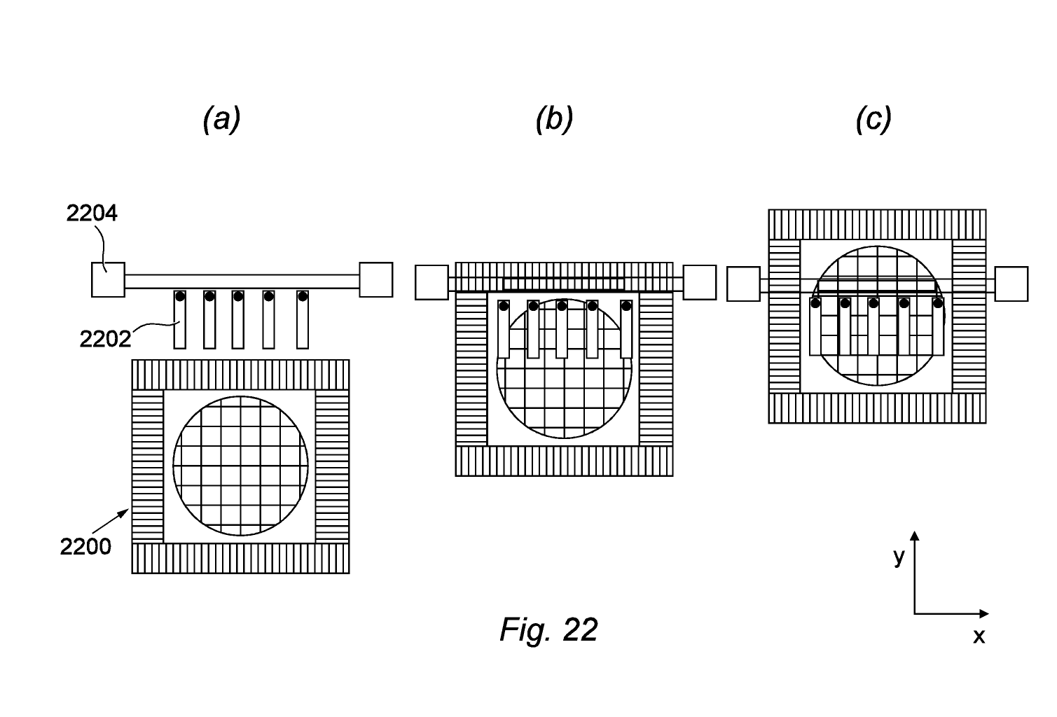

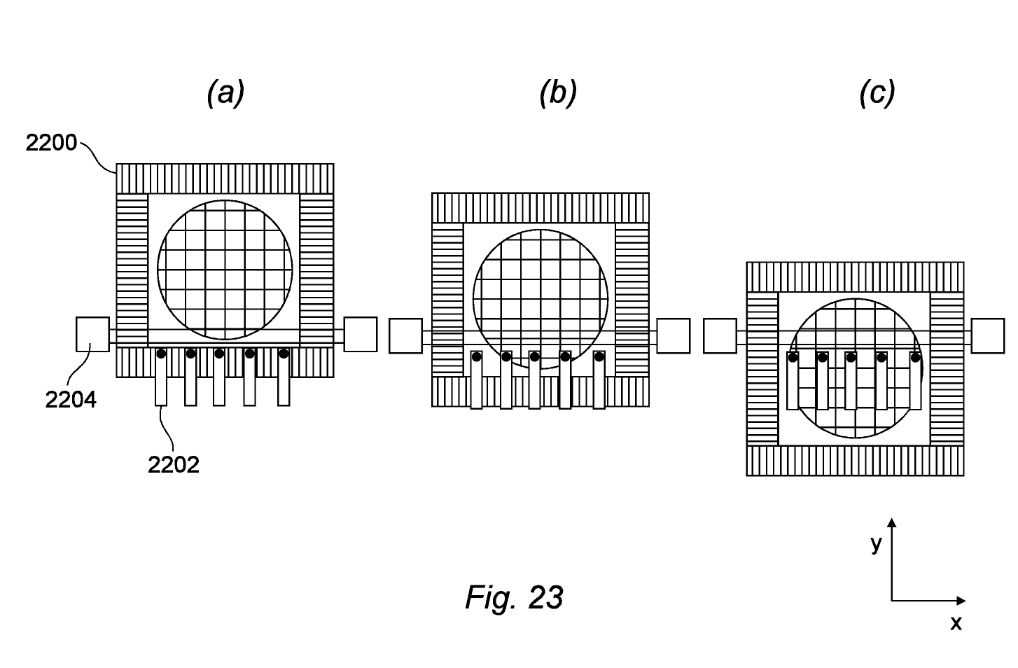

In the calibration method, a wafer is moved between successive positions in one of the x or y directions, without being adjusted in the other of the x or y directions. In each of the successive positions, one or more alignment sensors are arranged to measure alignment marks on the wafer, or on the wafer table, as derived from the interferometer elements. Then, in subsequent positions, the alignment sensors are arranged to measure different alignment marks on the wafer or wafer table. An example of this is illustrated in FIGS. 22 and 23, which shows various positions in a y-direction of a wafer table 2200, which is measured by alignment heads 2202 and leveling sensor 2204. In FIG. 22, the wafer table 220 moves in a first direction along a y-axis, from a position represented by FIGS. 22a, to 22b and then to 22c. In FIG. 23, the wafer table 2200 moves in the opposite direction along the y-axis, from a position represented by FIGS. 23a, to 23b, and then to 23c. An empty circle over an alignment head 2202 means that it is inactive, and a filled circle means that it is taking a measurement. The alignment sensor data gives x and y measurements, and since the relative positions of the alignment marks are known, one can solve for x, y and θz offsets of the wafer table 2200. (θz is the tilt of surface with respect to the x,y plane at a given position, z, along the z-axis).

As mentioned above and shown in FIGS. 9 and 10, a known lithographic apparatus has a leveling sensor comprising an irradiation system 908 and a detection system 910 with multiple sensors arranged in an array defining a detection area 906 having a length similar to the width of a wafer. The irradiation system 908 emits radiation at an oblique angle with respect to the x-y plane to be reflected and detected by the detection system 910. It is to be understood that the detection area 906 comprises a plurality of detection points, shown for ease of illustration as a detection area.

The leveling sensor system also comprises z sensors which are arranged to detect the position in a z-axis of the wafer table. In a focus and mapping operation, the detection of z position information across the wafer is determined. The leveling sensor system 908, 910 detects the z position on the wafer surface and the z-sensors detect the position of the wafer table, for successive stepped y values which are obtained by successive movements of the wafer table in the y-direction. The position in the z-axis of the wafer table acts as a datum point for the wafer z-height measured by the leveling system. Then during an exposure step, a set of secondary z sensors carried on the encoder arms 1004, 1006 detect the position of the wafer table. They measure the z-position and the tilt (in the y-axis) of the wafer table. The z position information previously obtained with the leveling sensor and first z sensors is used as a datum point for adjusting the z height of the wafer table. The adjustment in height of the wafer table is controlled by feedback from the secondary z sensors.

Because the z position information has been determined before, surface position control of the upper surface of the wafer can therefore be performed without actually obtaining surface position information of the wafer surface.

A focus calibration method can be performed. The wafer table is moved to an initial position in which one or more focus sensors irradiate a measurement plate that comprises a fiducial mark (the same plate and fiducial mark as mentioned above with respect to calibration of the alignment sensors). The z-sensors detect the position of the wafer table as before, and the focus sensors detect the position of the measurement plate including that of the fiducial mark, so that the relation in the z-axis between the wafer table and the fiducial mark is measured. Then, the wafer table is moved in the positive y direction by a predetermined amount, to a position in which the fiducial mark is aligned with a projected image from a reticle, passed through the lens elements of the lithographic apparatus. The z position is measured with the secondary z-sensors and then compared with the previously gathered relation in the z-axis between the wafer table and the fiducial mark is measured to obtain an offset of a representative detection point of the multipoint focus detection system, that is, the deviation between the best focus position of projection optical system PL and the detection origin of the multipoint focus detection system. This measured offset value can then be used to adjust the detection origin of the multipoint focus detection system so that the offset of the representative detection point of the multipoint focus detection system becomes zero. The adjustment can be carried out by either optical or electrical techniques, or alternatively the offset can be stored in a computer that performs the positional calculations, and be used as an adjustment factor in the calculations that are made.

The methods above rely on moving the wafer stage to bring the alignment marks into focus of the alignment sensors. However, moving the wafer table multiple times in the z-direction can increase errors in the measurements that are made, and can introduce mechanical stresses to the wafer.

An alternative way to bring the alignment marks into focus is to include a leveling sensor dedicated for use with one or more of the alignment sensors and being provided at the same axis as the or each alignment sensor, together with a mechanism for resolving focus differences.

The mechanism for resolving focus differences can comprise a mechanism to move each of the alignment heads on the basis of the results from the leveling sensor in order to bring the alignment mark into focus. Any suitable mechanism can be used to move the alignment heads, for example, one can think of a piezo-electric device used as an actuator to move the alignment head around or along a linear axis.

Alternatively, the mechanism for resolving focus differences can comprise a mechanism for adjusting the focus of the multiple alignment sensors, by changing the focal lengths. This can be done by changing the distances between the various optical elements comprising the alignment sensor.

It is also possible to provide both these mechanisms (i.e. a mechanism for movement of the alignment head and a mechanism for adjusting focus) in the same alignment head, in which case either mechanism can be selectively operated depending on the circumstances of any given situation.

Therefore, the complete set of alignment marks can be in focus while the wafer table is maintained in a given z position. The z-sensors can be provided in one, a plurality or every alignment head in a secondary alignment head system, and/or in an alignment head of a fixed (primary) alignment head. The z-sensor can be integrated into the structure of an alignment head.

In one embodiment, the calibration of the sensor focus difference, using either of the mechanism for movement of the alignment head and a mechanism for adjusting focus, can be a coarse calibration, with fine calibration then being carried out by adaptation of the focal lengths of the alignment sensors to a maximum contrast or minimum phase contrast (i.e. correct focus) while the alignment marks are scanned. Using multiple alignment sensors, a streaming/scanning scan can be made of the wafer to measure the aligned positions constantly adapting the focus to minimum contrast and maximum contrast. No further movement of the sensors in the z-direction is generally required as focus adjustment can solve this.

In a further embodiment, a pre-alignment sensor can be provided at each alignment head to predetermine the optimal focus. The pre-alignment sensor comprises a sensor with a variable focal length which can be adapted to a maximum contrast or minimum phase contrast (i.e. correct focus). The pre-alignment can for example be a ring-like sensor around the alignment sensor to allow 360 degree scan flexibility. The alignment sensor can then move in the z-direction or adjust its focal length depending on the readings from the pre-alignment sensor.

In the alignment techniques mentioned above with respect to FIGS. 9 to 17, the leveling measurement can be performed in the same scan as the alignment measurement. However, the acceleration/deceleration can tend to warp the chuck and/or the wafer.

In an alternative technique, the leveling is performed first in a smooth motion (that is, at almost constant velocity during the main part of the motion), and then the alignment measurement is performed on a return scan.

FIG. 22 illustrates a scan in a first direction, in which the focus measurement is performed by the leveling sensor, without alignment being measured. Because the alignment heads are inactive, the focus measurement can be thought of as being positioned sequentially before the alignment sensors.

Then, the alignment is measured by scanning in a second direction. This is illustrated in FIG. 23. In an embodiment multiple alignment heads can be used as discussed above. Optionally, a further focus measurement using the leveling sensors can be performed during the scanning in the second direction.

In an embodiment, the first and second scanning directions are opposite directions, for example, opposite directions of motion along a y-axis, or indeed an x-axis.

In the alignment techniques mentioned above with respect to FIGS. 9 to 18, the alignment measurement is performed, followed by the leveling measurement, during a scan.

In an alternative technique, this order is swapped, and the leveling measurement is performed before the alignment measurement.

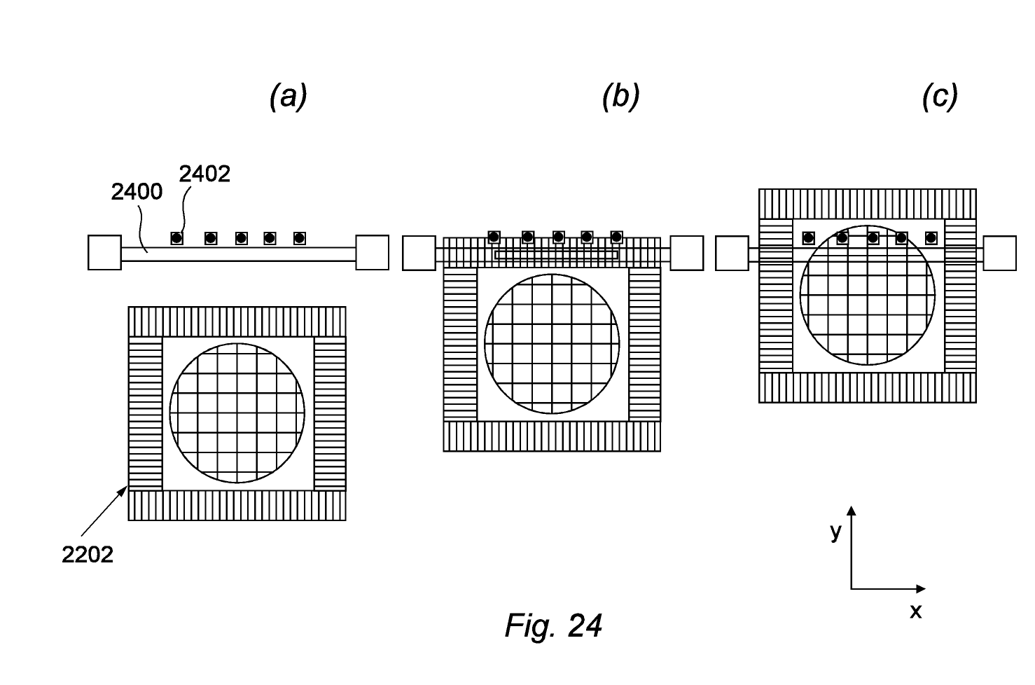

One embodiment of this technique is illustrated in FIG. 24, showing schematically a system in which the leveling sensor 2400 is placed “ahead” of the alignment sensors 2402. When the wafer table 2200 is moved in a first direction in the y-axis, from the position represented by FIGS. 24a, to 24b and then to 24c, the leveling sensor 2400 detects information from a given detection area on the wafer before the alignment sensors 2402 detect information from the same detection area.

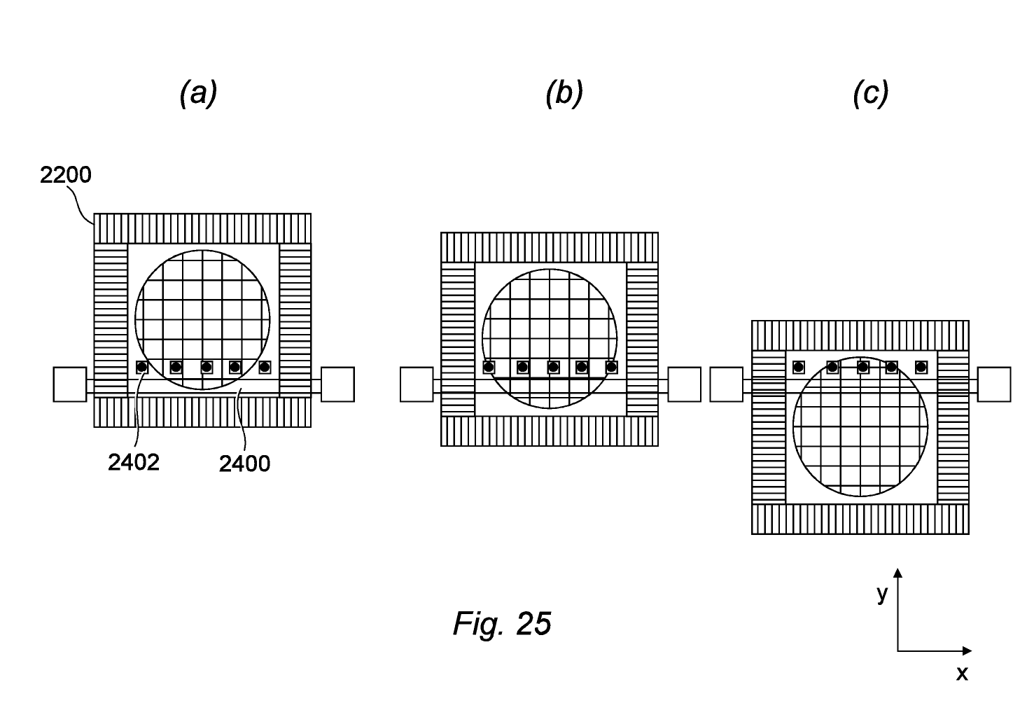

In an alternative embodiment of this technique a second scan in the second scanning direction is used to perform a second focus measurement. This is shown in FIG. 25. When the wafer table 2200 is moved in a second direction in the y-axis, from the position represented by FIGS. 25a, to 25b and then to 25c; that is, in a direction opposite to the direction shown in FIG. 24; the alignment sensors 2402 detect information from a given detection area on the wafer before the leveling sensor 2400 detects information from the same detection area.

There are some focus measurement differences between the scan in the first direction and the scan in the second direction. The focus is measured for both the first and second scanning directions. Then the two measurements can be averaged, or the first scanning direction focus measurement is used when exposing in the first scanning direction (and, the second scanning direction focus measurement is used when exposing in the second scanning direction).

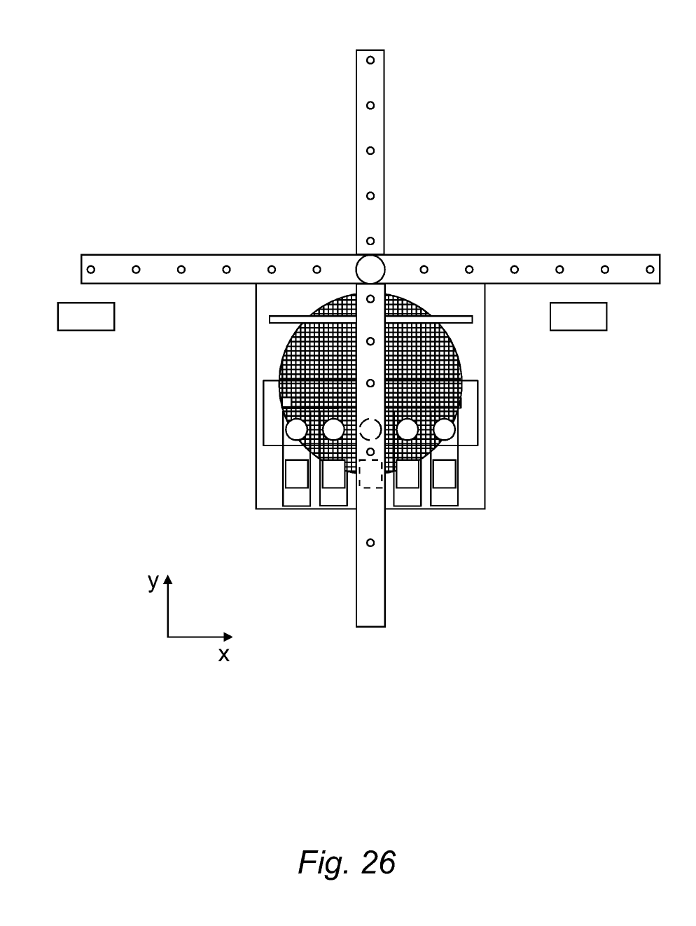

In a further feature, a z-sensor can also be placed ahead of the alignment sensors, as shown in FIG. 26.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g. having a wavelength of or about 365, 355, 248, 193, 157 or 126 nm) and extreme ultra-violet (EUV) radiation (e.g. having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of claims based on this disclosure.

Aspects of embodiments in accordance with the present invention include one or more of the following alone or in any combination.

A lithographic apparatus including apparatus for measuring the alignment of an object, including a plurality of alignment sensors, each including an alignment detector for measuring the position of an alignment mark over an alignment detection area, and a leveling sensor for measuring the height and/or tilt of an object in a leveling sensor detection area, and a feed-forward connection between the leveling sensor and the alignment sensors.

A lithographic apparatus wherein the leveling sensor detection area is physically separate from the alignment detection area.

A lithographic apparatus wherein the leveling sensor detection area and the alignment detection area are provided at or along offset parallel axes.

A lithographic apparatus wherein the alignment sensors are arranged to receive height and/or tilt data from the leveling sensor through the feed-forward connection and to adjust their position based upon the data that is fed-forward, so that each alignment head is positioned at an in-focus position.

A lithographic apparatus including a data processor arranged for receiving the measured position of an alignment mark and the measured height and/or tilt of an object and for using the measured height and/or tilt of the object to determine a correction factor for the measured position of an alignment mark.

A lithographic apparatus including a mechanism for moving the plurality of alignment sensors and the leveling sensor across an object in a scanning operation, and arranged for measuring the position of one or more alignment marks and for measuring the height and/or tilt of an object at one or more points during, or throughout the course of, the scanning operation.

A lithographic apparatus wherein said scanning operation is carried out in one direction.

A lithographic apparatus wherein each of the alignment sensors includes an image sensor housed in an alignment head, each of the alignment heads being movable independently.

A lithographic apparatus further including an alignment head that is fixed to a metrology frame.

A lithographic apparatus wherein the object is a wafer, and said alignment mark is provided on a wafer surface, or on a wafer stage or measurement stage.

A method of measuring the alignment of an object in or associated with a lithographic apparatus, including measuring the position of a plurality of alignment marks, each measurement being made over an alignment detection area, measuring the height and/or tilt of an object in a leveling sensor detection area, and feeding-forward the measured height and/or tilt to provide a correction for the measured position of the plurality of alignment marks.

A method of measuring the alignment of an object wherein the leveling sensor detection area is separate from said alignment detection area.

A method of measuring the alignment of an object wherein the leveling sensor detection area and the alignment detection area are provided at or along offset parallel axes.

A method of measuring the alignment of an object including adjusting the position of one or more alignment sensors based on the data that is fed-forward, so that each alignment head is positioned at an in-focus position.

A method of measuring the alignment of an object including using a measured height and/or tilt of said object to determine a correction factor for the measured position of an alignment mark.

A method of measuring the alignment of an object including moving a plurality of alignment sensors and a leveling sensor across an object in a scanning operation and measuring the position of one or more alignment marks and measuring the height and/or tilt of an object at one or more points during, or throughout the course of, the scanning operation.

A method of measuring the alignment of an object wherein the scanning operation is carried out in one direction.

A method of measuring the alignment of an object wherein alignment heads of one or more alignment sensors are moved in response to the correction provided by the data that is fed-forward.

A method of exposing a wafer, including reconstructing a wafer model, said reconstruction of the wafer model including measuring the alignment of the wafer by measuring the alignment of an object in or associated with a lithographic apparatus, including measuring the position of a plurality of alignment marks, each measurement being made over an alignment detection area, measuring the height and/or tilt of an object in a leveling sensor detection area; and feeding-forward the measured height and/or tilt to provide a correction for the measured position of a plurality of alignment marks, and carrying out an exposure based on the reconstructed wafer model.

A lithographic apparatus including apparatus for measuring the alignment of an object, including a stage for carrying an object, a measuring device for measuring the position of the stage, a plurality of alignment sensors, each including an alignment detector for measuring the position of an alignment mark over an alignment detection area, a mechanism for moving said alignment sensors between one or more successive positions in a first direction without being moved in a second direction and a calculator for comparing the output of the measuring device at two or more of the successive positions with the output of said alignment sensors, and for calculating a discrepancy in the shape of the stage based on the outputs.

A lithographic apparatus wherein a measuring device for measuring the position of the stage comprises an interferometer.

A lithographic apparatus wherein each alignment sensor includes an image sensor housed in an alignment head, each of the alignment heads being movable independently of each other.

A lithographic apparatus further including an alignment head that is fixed to a metrology frame.

A lithographic apparatus wherein the alignment mark is provided on a wafer surface or on a wafer stage or measurement stage.

A lithographic apparatus including apparatus for measuring the alignment of an object, including a plurality of alignment sensors, each including an alignment detector for measuring the position of an alignment mark over an alignment detection area, and a plurality of leveling sensors for measuring the height and/or tilt of an object in a leveling sensor detection area, each leveling sensor being dedicated for use with one or more of the alignment sensors.

A lithographic apparatus further including a mechanism for resolving focus differences.

A lithographic apparatus wherein the mechanism for resolving focus differences includes a mechanism to move each of the alignment heads on the basis of the results from the leveling sensor in order to bring the alignment mark into focus.

A lithographic apparatus wherein the mechanism for resolving focus differences includes a mechanism for adjusting the focus of the multiple alignment sensors, by changing the focal lengths.

A lithographic apparatus wherein the mechanism for movement of the alignment head and a mechanism for adjusting focus are provided in the same alignment head.

A lithographic apparatus wherein each leveling sensor is provided at the same axis as the or each alignment sensor, with which it is dedicated for use.

A lithographic apparatus wherein the leveling sensor detection area and the alignment detection area are provided at or along offset parallel axes.

A method of measuring the alignment of an object using a lithographic apparatus in accordance with the foregoing embodiments.

1. A lithographic apparatus comprising apparatus for measuring the alignment of an object, comprising:
a plurality of alignment sensors, each comprising an alignment detector for measuring the position of an alignment mark over an alignment detection area; and
a leveling sensor for measuring the height and/or tilt of an object in a leveling sensor detection area; and
a feed-forward connection between said leveling sensor and said alignment sensors.

2. The lithographic apparatus of claim 1, wherein said leveling sensor detection area is separate from the alignment detection area.

3. The lithographic apparatus of claim 2, wherein the leveling sensor detection area and the alignment detection area are provided at or along offset parallel axes.

4. The lithographic apparatus according to claim 1, wherein the alignment sensors are arranged to receive height and/or tilt data from the leveling sensor through the feed-forward connection, and to adjust their position based upon the data that is fed-forward, so that each alignment head is positioned at an in-focus position.

5. The lithographic apparatus according to claim 1, further comprising a data processor arranged for receiving the measured position of an alignment mark and the measured height and/or tilt of an object, and for using the measured height and/or tilt of the object to determine a correction factor for the measured position of the alignment mark.

6. The lithographic apparatus according to claim 1, comprising a mechanism for moving the plurality of alignment sensors and the leveling sensor across an object in a scanning operation, and arranged for measuring the position of one or more alignment marks and for measuring height and/or tilt of an object at one or more points during, or throughout the course of, the scanning operation.

7. The lithographic apparatus according to claim 1, wherein each of the alignment sensors comprises an image sensor housed in an alignment head, each of the alignment heads being movable independently of each other.

8. The lithographic apparatus according to claim 7, further comprising an alignment head that is fixed to a metrology frame.

9. The lithographic apparatus according to claim 1, wherein the object comprises a wafer, and said alignment mark is provided on a wafer surface, a wafer stage or a measurement stage.

10. A method of measuring the alignment of an object in or associated with a lithographic apparatus, comprising;
measuring the position of a plurality of alignment marks, each measurement being made over an alignment detection area;
measuring the height and/or tilt of an object in a leveling sensor detection area; and
feeding-forward the measured height and/or tilt to provide a correction for the measured position of a plurality of alignment marks.

11. The method according to claim 10, wherein said leveling sensor detection area is separate from said alignment detection area.

12. The method according to claim 10, wherein said leveling sensor detection area and said alignment detection area are provided at or along offset parallel axes.

13. The method according to claim 10, further comprising adjusting the position of one or more alignment sensors based on the data that is fed-forward, so that each alignment head is positioned at an in-focus position.

14. The method according to claim 10, further comprising using a measured height and/or tilt of said object to determine a correction factor for said measured position of an alignment mark.

15. The method according to claim 10, further comprising moving a plurality of alignment sensors and a leveling sensor across an object in a scanning operation, and measuring the position of one or more alignment marks and measuring the height and/or tilt of an object at one or more points during, or throughout the course of, said scanning operation.
